(19) United States
(12) Patent Application Publication
(10) Pub. No.: US 2010/0181996 A1
(43) Pub. Date: Jul. 22, 2010

(54) MOVEMENT RANGE FOR A MOBILE OBJECT AND EVALUATION APPARATUS FOR DETERMINING A POSITION OF A MOBILE OBJECT

(76) Inventors: Walter Englert, Burgrieden (DE); Tilman Bucher, Munich (DE)

Correspondence Address: GLENN PATENT GROUP, 3475 EDISON WAY, SUITE L, MENLO PARK, CA, 94025, US

(21) Appl. No.: 12/598,421

(22) PCT Filed: Mar. 20, 2008
(86) PCT No.: PCT/EP08/02270

§ 371 Date: Mar. 5, 2010

(30) Foreign Application Priority Data
Mar. 30, 2007 (DE) 10 2007 015 493.5

(51) Int. Cl. G01B 7/14

(52) U.S. Cl. 324/207.22

(57) ABSTRACT

In order to determine a position of a mobile object relative to a surface within a movement range that comprises a ground which the surface intersects along a line of intersection, a magnetic field of a first elongate magnetic field-generating object which is located at a first distance from the line of intersection is measured, and a magnetic field of a second elongate magnetic field-generating object that is located in or on the ground, at a second distance on another side of the line of intersection, is measured. Based on a comparison between the measured magnetic fields, it is determined whether the mobile object is located in front of or behind the surface. A generator that triggers the magnetic field-generating objects in a multiplex mode is provided for distinguishing which magnetic field-generating object generates which magnetic field. The magnetic field-generating objects can comprise forward conductors of a conductor loop, oppositely wound coils, or forward/return conductor combinations having a magnetically shielded return conductor.

### CROSS-REFERENCE TO RELATED APPLICATIONS

This application is a national phase entry of PCT Patent Application Serial No. PCT/EP2008/002270, filed 20 Mar. 2008, which claims priority to German Patent Application No. 10 2007 015493.5, filed 30 Mar. 2007 and U.S. Patent Application Ser. No. 60/909,364 filed 30 Mar. 2007, each of which is incorporated herein by reference.

### DESCRIPTION

The present invention refers to position detection systems and particularly to the detection of a position of a mobile object in a movement range with respect to a surface in the movement range.

Disputes often occur in soccer but also in other sports whether a ball was in the goal or not. Each sport with the aim of bringing a ball to a certain position with respect to a surface has more or less complex rules as to when a ball has passed a line or was in a goal or not. Particularly in sports in which a ball or a mobile object moves relatively fast, such as in soccer, handball, football, ice hockey etc., it is usually relied upon a referee, who together with further referees, such as a linesman, decides whether a goal has been shot or not. Such a decision is not difficult if the ball stays in the goal, i.e. if it stays in the net, which definitely indicates that a goal has been shot. However, if the ball bounces shortly behind the goal line and then bounces out of the goal, it cannot clearly be determined whether a goal has been shot or not.

In such a case, certain sports allow an interruption of the game and it is analyzed by means of a high-speed camera whether the ball has passed the line or not. Soccer for instance requires that the ball has passed the goal line with a complete revolution, i.e. with an entire diameter so that a goal is given.

Such technical analyses by using high-speed cameras are expensive, technically complex and require time for evaluation. Furthermore, a referee is still needed, who has to watch a television picture to decide by the aid of this television picture whether a goal was shot or not. The high-speed cameras do therefore not create a technically generated proposal whether a goal has been shot or not that can be adopted by a referee or which can be used by a referee at least as an aid for making his own decision.

Optical analysis systems can therefore provide a relatively safe goal decision if high-speed cameras are used. However, they were not able to actually find their way into sports due to the fact that they are very expensive, lead to long interruptions of a game and can thereby effect that a formerly exciting game is torn apart due to permanent analysis breaks, which does in the end neither please the players, nor the clubs, nor the spectators.

The object of the present invention is to provide an improved concept for position detection.

This object is solved by a movement range according to claim 1, an evaluation device according to claim 17 or 31, a method of operating a movement range according to claim 33, an evaluation method according to claim 34 or 35 or a computer program according to claim 36.

The present invention is based on the knowledge that a simple but still operatively safe and precise measurement is based on relying on magnetic fields that are influenced relatively few by players and other subjects to be expected on the playing field. Furthermore, a set of at least magnetic field generating objects is used for magnetic field generation, said objects being arranged on or in the ground in the proximity of a surface with respect to which the position of the mobile object shall be determined. Particularly, a first elongate electrically conductive magnetic field generating object is arranged from an intersecting line of the surface with the ground on or in the ground, and a second elongate electrically conductive magnetic field generating object is arranged at a distance from the intersecting line from the second side of the intersecting line in or on the ground.

Both magnetic field generating objects generate, since in the case of a simple conductor they do for instance only detect the forward conductor, a magnetic field that radially decreases. The decrease characteristics of the magnetic field of a straight conductor is known and proportional to l/r, wherein r is the distance from the conductor. Due to the fact that one conductor is arranged in front of the surface and one conductor is arranged behind the surface, a conclusion can be drawn on the position of the mobile object only based on a comparison of the magnetic fields caused by the conductors in a multiplex mode. If the magnetic field caused by the conductor in front of the surface is larger than the magnetic field caused by the conductor behind the magnetic field, it can be said that the mobile object is located in front of the surface or that it was located there at the time of measurement, while, if the magnetic field caused by the conductor is larger behind the surface than the magnetic field caused by the conductor in front of the surface, it can be said that the mobile object was located behind the surface at the time of measurement.

If the respective surface has a lateral limitation, such as if a goal is concerned defining a surface that is laterally limited, at least one further magnetic field generating object also in the form of a straight conductor is arranged, which is arranged at an acute angle or preferably perpendicularly with respect to the other two magnetic field generating objects. This third magnetic field generating object is also excited in the multiplex mode and solely supplies via a threshold comparison an indication whether the object is located within or outside of the limitation of the surface. If, however, in addition to the third magnetic field generating object a fourth magnetic field generating object is arranged, wherein among the third and the fourth magnetic field generating object one of them is located within the limitation and one is located outside of the limitation, it can be determined only due to a comparison between the two magnetic field values analogously to the first two magnetic field values, whether the mobile object was located within or without the limitation at the time of measurement.

If the surface is limited towards the top, as is the case in soccer, or towards the bottom, it is preferred to make a threshold value comparison in a manner that if one of the potential four magnetic fields or a subgroup of the four magnetic fields is smaller than a threshold, the result is obtained that the ball was above the goal and not in the goal. If, however, the value measured by the magnetic field is larger than a threshold, it can be assumed that the ball was located closer to the ground and was therefore below the crossbar.

Only if the ball was detected behind the goal line caused by the first two magnetic fields, if the ball was detected between the two posts caused by the second and third magnetic field generating object, and if it is also detected that the ball was lower than a predetermined height, is e.g. in soccer a goal signalized under the condition that a post correction means, which has tracked the course of the ball in a more or less detailed manner, does not effect any goal signal deactivation. If the ball enters the goal from an area which was set due to prior knowledge about allowed and forbidden trajectories of the ball, a goal signal output is not generated despite the fact that the three above-mentioned criteria are fulfilled.

It is pointed to the fact that the principle of plausibility check of the position of the mobile object with respect to the surface can be used independent of magnetic field generating objects per se and particularly independent of the described elongate straight conductors or coils, i.e. also in the case of an optical detection, if an earlier position of the ball is considered to follow a more or less rudimentary ball trajectory. In this case, a neutral range, a switch-on range and a switch-off range is defined. A goal signal activation can e.g. take place only if the ball was moved out of the neutral range into the goal. A goal signal activation can, however, not take place if the ball was placed in the goal from the switch-out range via the neutral range, i.e. without moving over the switch-on range.

Preferred embodiments of the present invention will now be explained in detail with reference to the attached drawings.

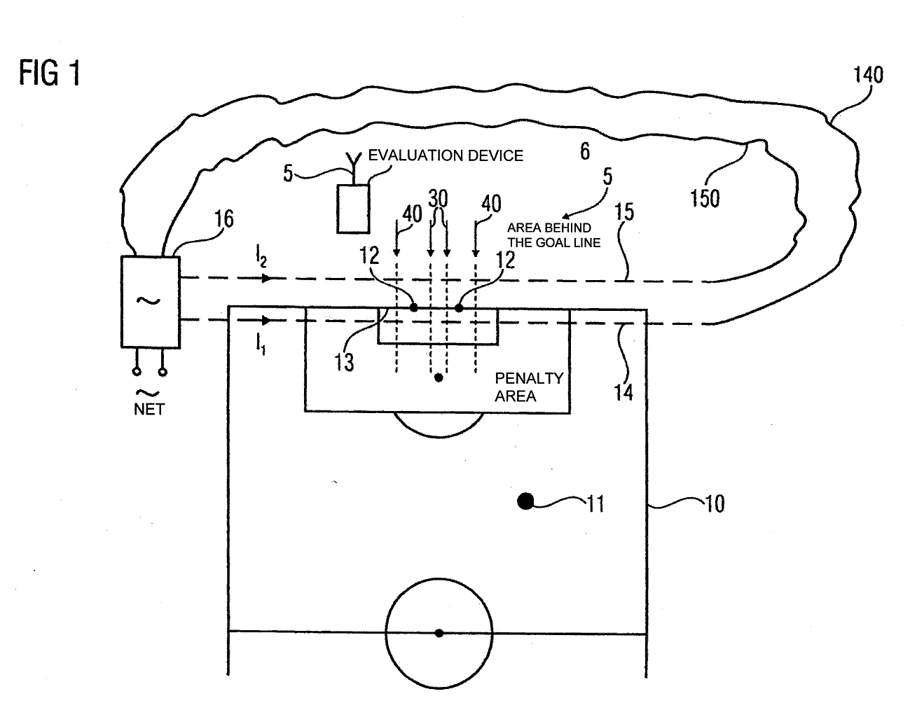

FIG. 1 is a schematic view of a first embodiment;

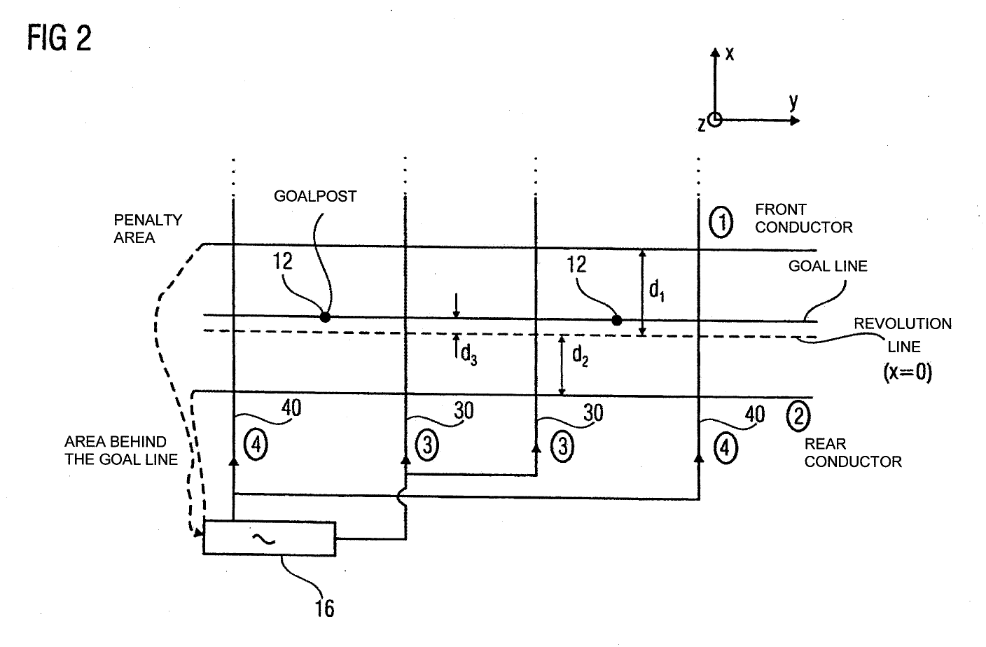

FIG. 2 is a detailed view of the arrangement of the magnetic field generating objects with respect to a goal;

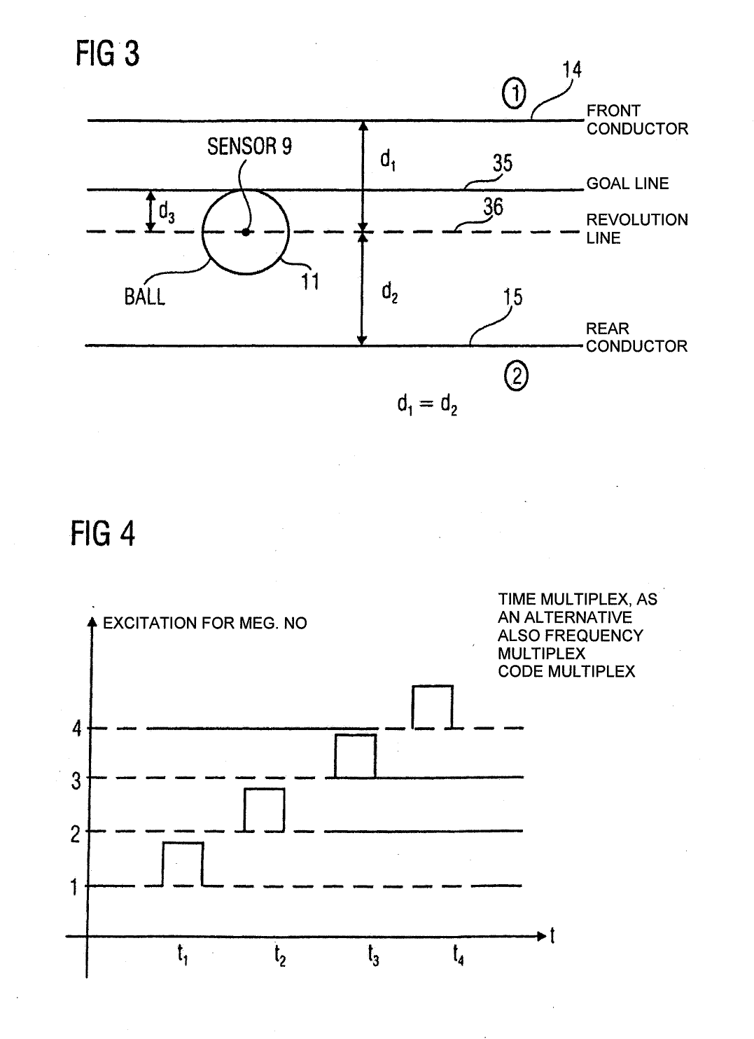

FIG. 3 is a detailed view to elucidate the position of the revolution line to the goal line and to the front and rear conductor;

FIG. 4 is a time diagram to illustrate a time multiplex excitation of four magnetic field generating objects;

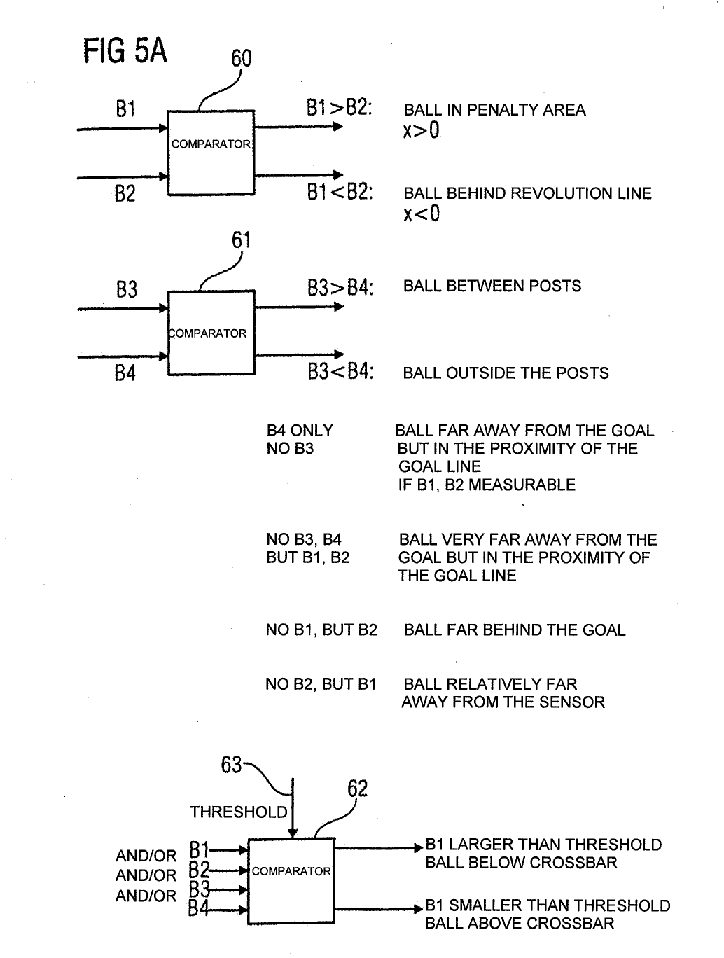

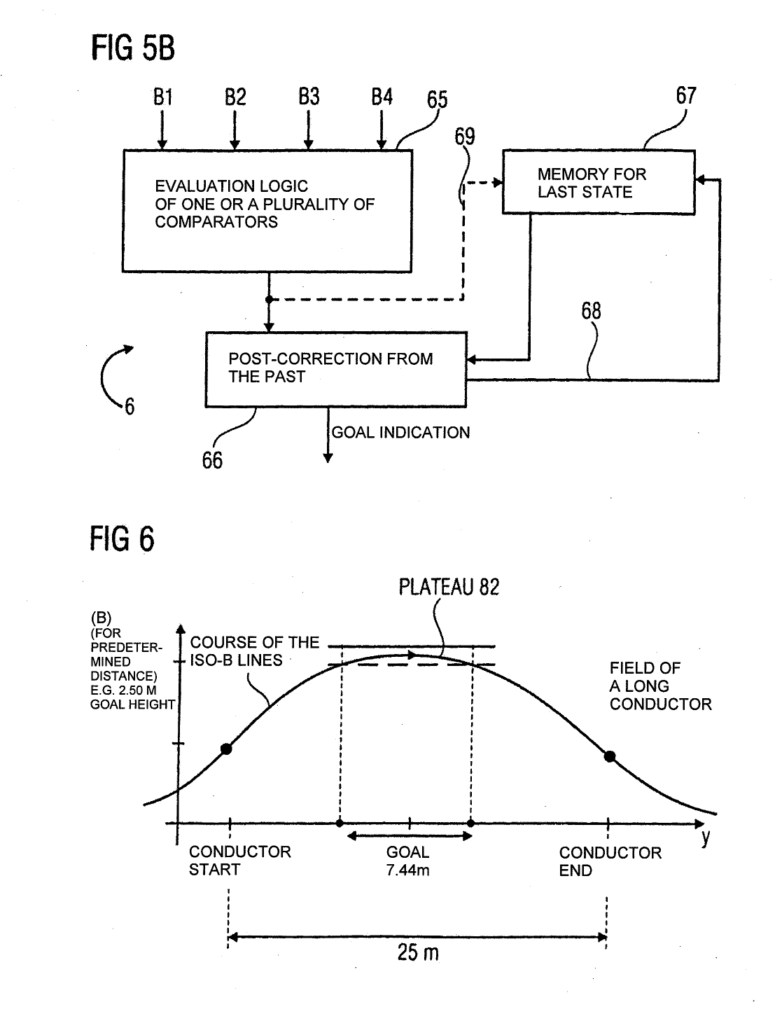

FIG. 5a is a schematic view of different logical operations to detect determined positions with respect to a surface in the movement range;

FIG. 5b is a schematic view of the evaluation device;

FIG. 6 is a view of the magnetic field relations in macroscopic dimensions with respect to a soccer goal with a goal width of 7.44 m;

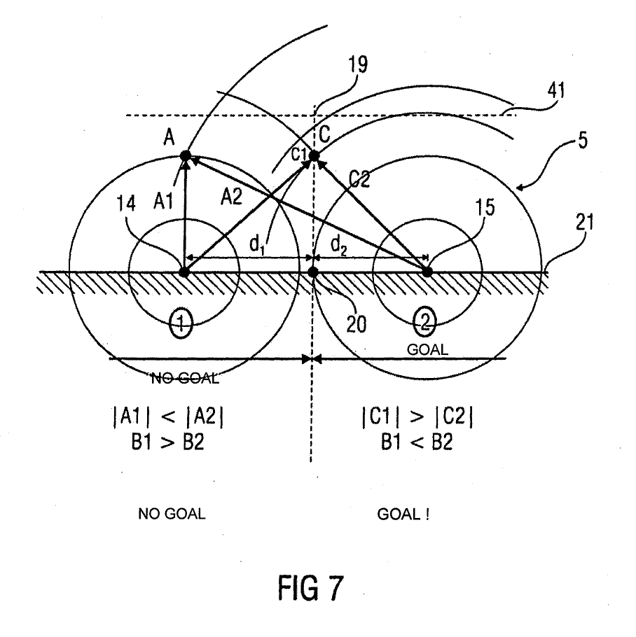

FIG. 7 is a schematic view of the magnetic field situation of two magnetic field generating objects with respect to the surface;

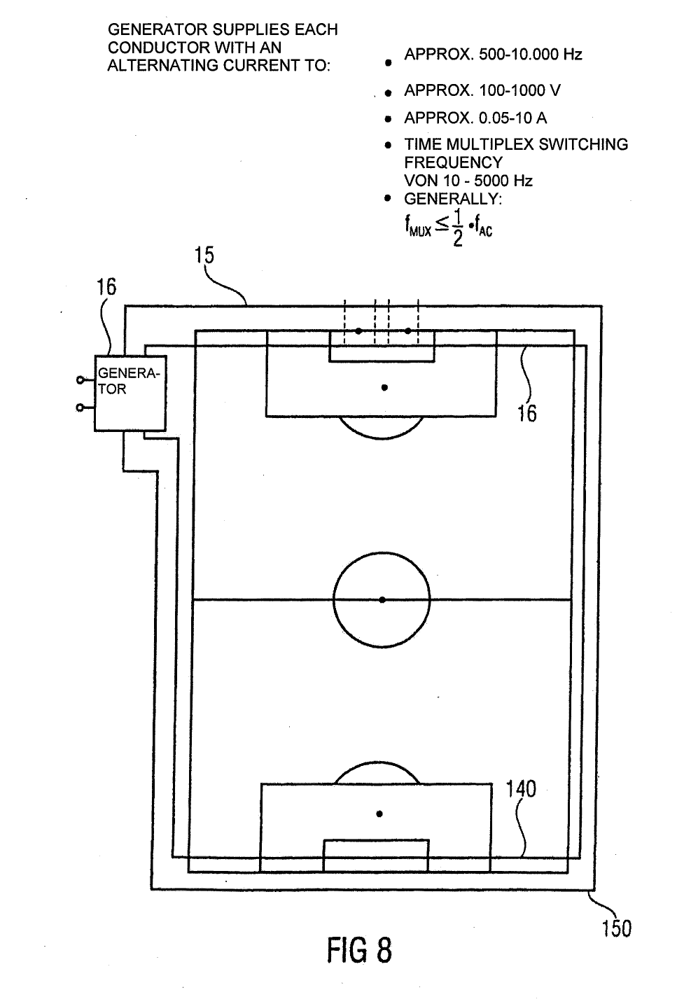

FIG. 8 is an alternative arrangement of the magnetic field generating objects for a soccer field with movement ranges located far away from each other;

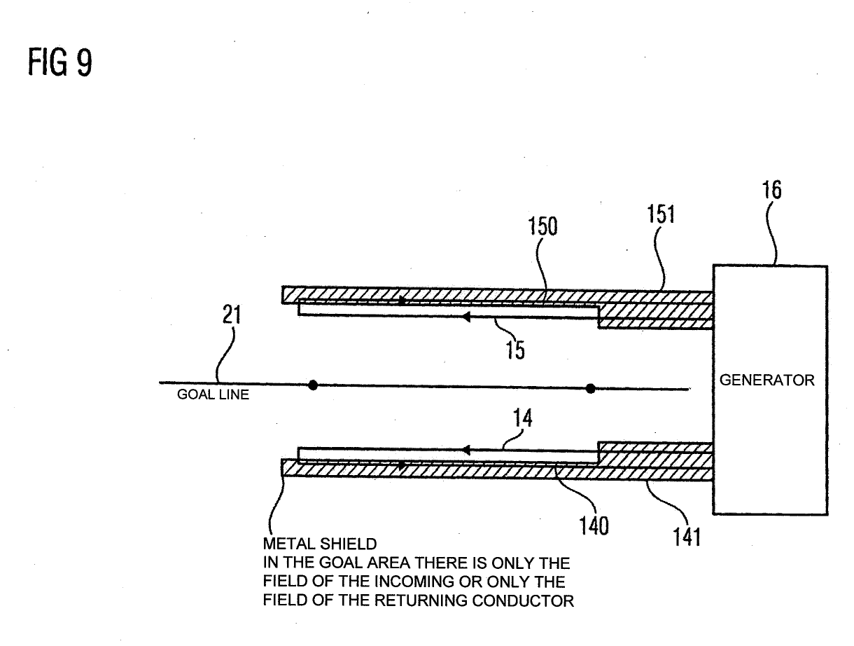

FIG. 9 is an alternative implementation with a shield of the return-conductor of a forward/return-conductor construction of the magnetic field generation means;

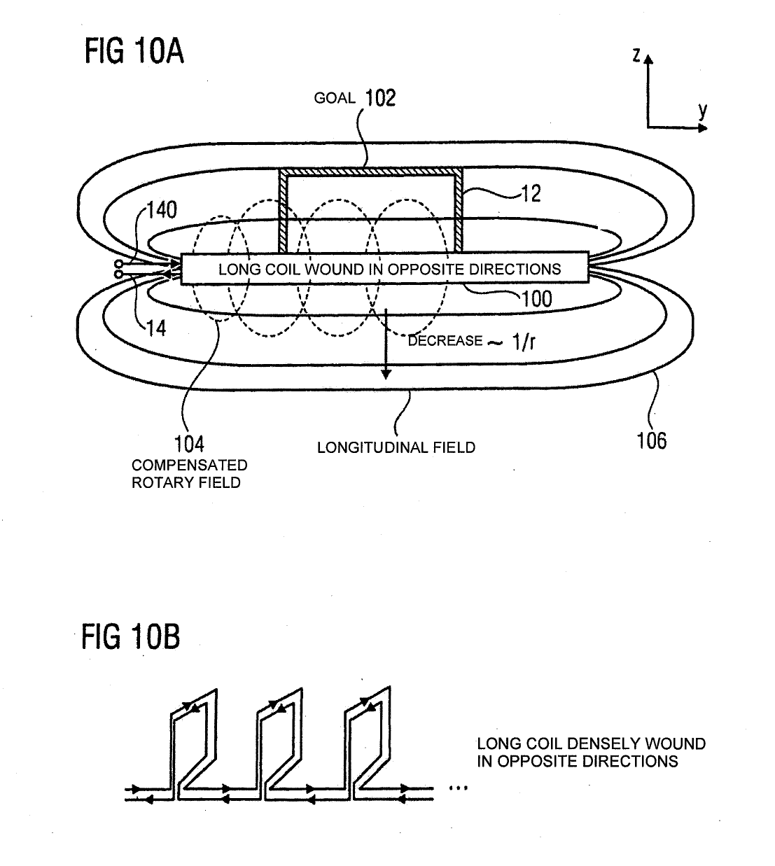

FIG. 10a is a schematic view of the longitudinal field of a long coil that is wound in opposite directions in which the rotary field is compensated;

FIG. 10b is an enlarged view of a section of the boil of FIG. 10a;

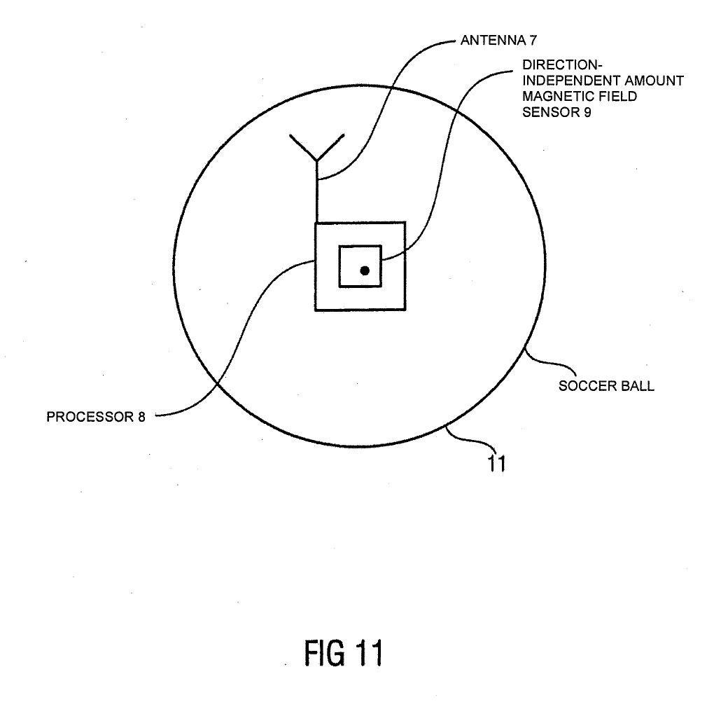

FIG. 11 is a schematic view of the mobile object by the example of a ball;

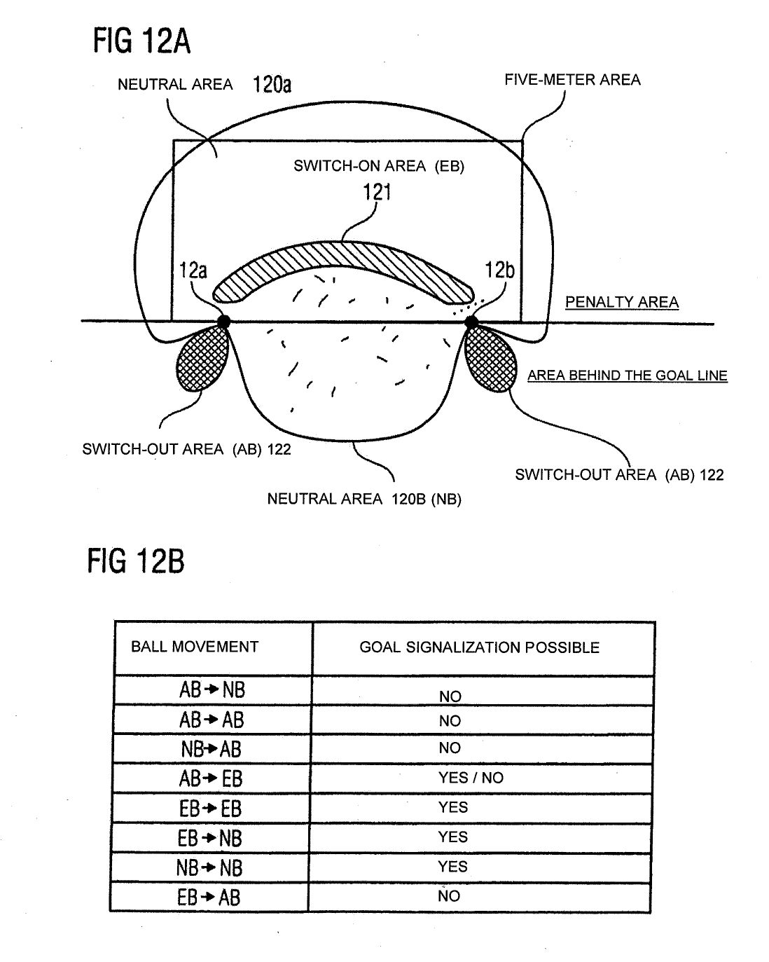

FIG. 12a is a top plan view onto an movement range with a neutral range, switch-off range and switch-on range; and

FIG. 12b is a schematic view of the possible state transitions as used by the evaluation device to carry out a plausibility check or to generally activate or deactivate a goal signalisation.

FIG. 1 shows a movement range, such as a goal range of a soccer field 10, for a mobile object, such as a soccer ball 11, which as shown in FIG. 1 is located far away from the penalty area, i.e. it is not yet located in the movement range in which measurement takes place. Generally, the position of the mobile object must be detected with respect to a surface in the movement range. The surface in the movement range is for instance a surface defined by a goal, whose goal posts are shown at 12, or, to be more precise, a surface which is parallel to the surface defined by the goal, but which is offset towards the back by half of a ball diameter, if the goal is defined in that a ball has completely passed through the surface defined by the goal, or the surface defined behind the goal is passed exactly halfway by the ball.

The movement range particularly has a ground, such as the soccergreen in the penalty area, wherein the surface concerned intersects the ground, i.e. it is not located in parallel to the ground but preferably even perpendicular to the ground. Of course, deviations in the structure of a soccer goal, a handball goal or an ice hockey goal etc. can exist in a manner that the surfaces are not located necessarily 100% vertical to the ground but in a predetermined tolerance range vertically to the ground, wherein this tolerance range, depending on the implementation, is aligned plus or minus 5° from the vertical or maybe plus or minus 10° from the vertical, depending on the size of the goal. Since the surface, however, intersects the ground, an intersecting line exists that is identical to the goal line or the revolution line, which is shown by 13. For position detection, a first elongate conductive magnetic field generating object 14 is provided, which is arranged at a first distance d₁ (FIG. 2) from the intersecting line on a first side of the intersecting line in or on the ground. Furthermore, a second elongate electrically conductive magnetic field generating object 15 is arranged that is arranged at a second distance d₂ (FIG. 2) from the intersecting line on a second side of the intersecting line in or on the ground.

It must be pointed to the fact the two magnetic generation objects 14, 15 can be buried in the ground, i.e. below the soccergreen, or they can rest on the green depending on which alternative is safe. For sports such as soccer it is preferred to burry the two elongate magnetic generating objects or at least to burry the front magnetic field generating object 14 so that it is not displaced if for instance a soccer game takes place.

Furthermore, the first and the second magnetic field generating object 14, 15 are adapted to generate a magnetic field radially decreasing with an increasing distance with respect to the magnetic field generating object.

Furthermore, a generator 16 is provided, which is adapted to control the two magnetic generating objects with an alternating current and in a multiplex mode. The alternating current amplitude is indicated in FIG. 1 for both conductors as I₁, I₂. Depending on the implementation, an alternating current or direct current is used. In order to become independent from the Earth's magnetic field or to reach a state in which magnetic fields were sufficient that are substantially smaller than the Earth's magnetic field, it is preferred to supply alternating current into the two magnetic generating objects 14, 15 through the generator 16. The directions of the current amplitudes I₁, I₂ are, however, arbitrary, which in the case of alternating current is clear anyway. In the case of a direct current, the directions are, however, also arbitrary, if this only changes the direction of the magnetic field. However, it is preferred to use a direction-independent magnetic field sensor in the ball 11 so that a direction of a magnetic field and thus a current direction of the current, as generated by the generator 16, is irrelevant.

The multiplex mode in which the generator 16 is operated, can be a time multiplex, a frequency multiplex, a code multiplex or a combination of different types of multiplex, such as a combined time and frequency multiplex.

Depending on the implementation it is preferred that the generator, as shown in FIG. 8, supplies an alternating current with a frequency between 500 and 10000 Hz and which is preferably between 2500 and 3500 Hz. Furthermore, the generator supplies a voltage with approx. 100 to 1000 Volt, which can particularly be between approx. 400 to 600 Volt. The current consumption of the conductor depends on various factors, particularly also on the length of the conductor and it is set depending on the implementation and goal size to a value between 0.05 and 10 A, wherein values in the range of 0.5 to 1.5 A are preferred for many applications. The switching frequency of the time-multiplex operation is between 10 and 5000 Hz, wherein it is generally preferred that the multiplex switching frequency f_{MUX}<< is smaller or equal to half of the alternating current frequency f_{AC} as indicated in FIG. 8.

The functionality of the present invention will now be explained with reference to FIG. 7. FIG. 7 shows in a section perpendicular to the goal the situation for two positions The first position A is not a goal, since the goal surface 19 lies on the right side with respect to position A.

Furthermore, it is assumed that the distance of the two conductors 14, 15 from the intersection line 20 of surface 19 with the ground 21 is spaced apart equally far from both conductors. In the example shown in FIG. 7, both distances d₁ and d₂ are therefore equally large. Since the magnetic field amounts decrease proportionally l/r, the magnetic field measured by a ball at position A and which comes from conductor 14, will be larger than the magnetic field coming from the conductor 15, since the position A is spaced apart from the conductor by distance AI, wherein this distance AI is smaller than the distance A2. Thus, a signalization is for instance output that a goal not been shot. This signalization is preferably implemented only as a result of the comparison of values B1 and B2 so that absolute value measurements, which would have to be calibrated, do not have to be used.

However, the position is reversed at position C. The distance C2 from point C to conductor 15 is smaller than the distance C1 of the point C to the conductor 14. Thus, it is detected that the ball is in the goal, since the magnetic field B1 is smaller than the magnetic field B2 that is measured by the ball if it is at position C.

It is pointed to the fact that the distances d₁ and d₂ of the two conductors do not necessarily have to be identical. For a simple comparison to function, the magnetic field should be equally large exactly on the surface of both conductors. In order to achieve this when the distances are not equally large, a supply with two different current amplitudes into the conductors can be operated as an alternative to the supply of an identical current amplitude. If for instance the distance d₂ is smaller than the distance d₁, the conductor 14 would have to be operated with a higher current amplitude to compensate for its “distance deficiency”. Thus, the value of the current amplitude is used for calibration purposes in an embodiment to compensate for placing inaccuracies. If, however, similar distances are reached, this calibration is not necessary and it can still be operated with a simple comparison. Due to the fact that the characteristics of the magnetic field is known, i.e. that the magnetic field l/r decreases, a calculation in the sense of a triangulation determination could be made based on the knowledge of the two distances d₁, d₂, even if the distances are not equally large and e.g. identical or arbitrarily known amplitudes are conducted through the conductor, to determine whether the position to be analyzed is located before or behind the surface 19. However, it is preferred to use the same amplitudes, the same distances and only one comparison to be able to signalize a state in front of or behind the goal.

In soccer and in many other sports, the surface is, however, limited laterally, namely by a goalpost 12, as shown in FIG. 2. FIG. 2 particularly shows an enlarged section of the situation of FIG. 1, wherein in FIG. 2 two further magnetic generation objects 30, 40 are arranged, whose functionality is analog to the functionality of the magnetic generation objects 14, 15, wherein the arrangement takes place perpendicular within a tolerance range of e.g. ±10°. Thus, a surface is effectively “monitored” located between the two conductors 30, 40 and which includes the goalpost 12. Due to the simple comparison of a magnetic field due to conductor 3 with a magnetic field due to conductor 4 it can be determined whether the ball was located within or outside of the goalpost.

As an alternative, one single third magnetic generating conductor arrangement in the center between the two goalposts would be sufficient, wherein a threshold comparison is sufficient to determine whether the magnetic field on the basis of the third conductor 30 has decreased by more than one threshold. If this is detected, the ball is outside of the goalpost, i.e. at a distance too far away from the centrally arranged conductor 3 as that a goal has been shot, whereas, if the magnetic field on the basis of the conductor 3 is larger than the threshold, a goal has been shot.

As an alternative, the two conductors 30 in FIG. 2 cannot exist and only the two conductors 40 exist. Then it would again be detected as a result of a threshold comparison that the magnetic field is small enough that the ball is located within the goalpost. In this case, the threshold is not a maximum threshold but a minimum threshold.

A soccer goal for instance also has an upper limitation, which is shown in FIG. 7 at 41 and which is provided by a crossbar. In order to detect whether a ball was above or below the crossbar 41, a threshold comparison is performed in an embodiment, namely a maximum threshold. If the magnetic field based on the conductor 14, 15 or if further conductors exist based on the conductor 30 or 40 is e.g. larger than the threshold that corresponds to the crossbar position 41, it is assumed that the ball was in the goal, whereas if a magnetic field is smaller than the threshold, it is assumed that the ball was above the upper limitation 41.

For this threshold comparison for detecting the position of the ball with respect to the upper limitation, both magnetic fields based on the first or second conductor 14 can be used. As an alternative, one single magnetic field would be sufficient. Furthermore, further magnetic fields can also be used, e.g. in the form of a weighted averaging, a majority decision etc.

Particularly in soccer is the detection whether a ball was above or below the cross bar relatively unproblematic, since when the ball was below the crossbar and has taken a “normal” trajectory, it stays in the net. If, however, the ball was above the crossbar, it will not end in the net and he will stay behind the goal. If, however, the ball bounces in the sense of a “Wembley” goal, which makes high demands on the detection, the detection in the vertical direction is unproblematic and the main object would be the relative comparison of the first and the second conductor, which operates with maximum accuracy and without a threshold. The upper threshold can therefore easily be used, since this dimension is the least critical dimension amongst all dimensions to be monitored.

All other dimensions, namely the lateral and front/rear position of the ball are obtained by a comparison of two measurements taken in two short time intervals so that systematic errors that equally relate to all measurements, wherein these errors are the most frequent ones, eliminate themselves based on the comparison.

FIG. 3 shows an even more detailed view of the situation in soccer, wherein the soccer rule is that a ball must have passed the goal line 35 with an entire revolution. Thus, a revolution line 36 exists, which extends in parallel to the goal line and which is spaced apart from the goal line about the radius of the ball. In an implementation of the present invention, the two distances d₁, d₂ are measured with respect to the revolution line and not with respect to the goal line, wherein if the two distances are measured with respect to the revolution line 36, the case is preferably used in which d₁=d₂, since then a simple comparison operation is sufficient for detection, as will be explained herebelow with respect to FIG. 5a. In the illustration shown in FIG. 3, it is assumed that the magnetic field sensor is arranged in the center of the ball, i.e. in the center of gravity of the ball, as it is shown at 9 in FIG. 3.

A schematic view of the ball 11 is shown in FIG. 11, wherein it is assumed that a processor 8 is arranged in the center of the ball, wherein this processor also preferably comprises exactly in is center the direction-independent amount magnetic field sensor 9, and wherein the detection data is transmitted via an antenna 7 to a remote detection/evaluation unit, which is for instance arranged in the goal area. Such an evaluation device 6 is shown in FIG. 1, wherein this evaluation device communicates preferably wireless with the ball or receives magnetic field measurements wireless from the ball. If, however, the evaluation device that is explained in detail with reference to FIGS. 5a and 5b is already arranged in the ball, the ball can perform the complete number of comparator operations to supply a goal decision itself, e.g. via a radio signal, and infrared signal, and acoustic and/or optical signal, e.g. by means of an LED that can be viewed on the ball itself and which for instance starts glowing when a goal has been shot.

Due to the fact that relations in the ball are robust for electronic circuits and due to the fact that a software update can more easily take place in the evaluation unit 6, it is, however, preferred that the ball 11 transmits magnetic field measuring values and that the entire evaluation takes place in the evaluation unit 6, which is arranged outside of the ball. The evaluation device could for instance send its information to a digital watch or any other small display device to the referees together with a vibration alarm or an acoustic alarm so that the referee is informed that the ball indicates a goal, to make a decision or to use this reference at least as a decision support.

FIG. 4 shows a time sequence as it can be carried out by the generator to operate the four conductors 14, 15, 30, 40 in a chronological manner in a second multiplex mode. The ball would then measure at time instants t₁, t₂, t₃, t₄ the current magnetic field and would know, when a correct synchronization was made, which measured value comes from which conductor. As an alternative, the ball could also simply send a sequence, and the evaluation device 6 would then on the basis of the order of the sequence as it was generated by the generator and on the basis of the order of the data received be able to make a further allocation. For this purpose, a wire-bound or wireless connection would exist between the evaluation device 6 and the generator 16.

However, it is also pointed to the fact that the generator 16 can, as an alternative, also operate in the frequency multiplex mode, i.e. in the code multiplex mode or in a combinatory multiplex mode, e.g. in a combined time/frequency multiplex mode. In the frequency multiplex mode, each conductor would have its own frequency, so that the generator 16 generates four different frequencies, which e.g. differ by 200 Hz, so that a convenient filtering can take place. In the co-demultiplex mode, each conductor would have its own code sequence that is orthogonal to the other code sequences so that an interference-free operation can be reached, which, however, if very fast ball movements are to be expected, can cause a relatively high switching frequency and thus a relatively high magnetic field frequency.

If, as shown in FIG. 1 and in the further Figures, a straight conductor 14, 15 is used for magnetic field generation, a magnetic field compensation will take place if the return conductor 14, 15 is arranged too close to the forward conductor 14, 15, so that a sensor signal does no longer exist. According to the invention, the return conductor 140 and the return conductor 150 are arranged relatively far away from both forward conductors. Depending on the implementation, such a far distance is striven for that in the range of interest, i.e. in the surface or proximity of the surface in the movement range a field generated on the basis of the return conductor is smaller than 10% and preferably smaller than 1% of the field that is generated in the surface of the movement range in front of the forward conductor 14 or 15, respectively. Although the return conductor could be implemented by a ground anchor, which is a cost-effective implementation, it is operated with a different implementation with a defined return conductor 140, 150, since defined relations will then exist and not randomly a return conductor current path, that results e.g. due to geological relations, but still passes very close to the surface in the movement range and would therefore affect the measuring accuracy.

The generator 16 is an alternating current generator with the required data and is connected to the net. A galvanic decoupling can possibly take place for a transformer so that net problems are not generated or affect the measurement.

FIG. 5a shows a schematic view of the functionalities that have to be performed by the evaluation device, which is shown in FIG. 1 and which is shown in more detail in FIG. 5b.

Particularly, a first comparator function 60 is made to compare the magnetic field value on the basis of the first conductor 14 (B1) with the magnetic field measuring value based on the second conductor 15 (B2). If B1 is larger than B2, the ball is in the penalty area, i.e. it definitely in front of the goal line, whereas the ball, if B1 is smaller than B2, is located behind the revolution line 36. Whether the ball is in the goal or not is only determined by the comparison made by the comparator 61. In this case, the magnetic field values are compared on the basis of the conductors 30, 40, i.e. B3, B4, to determine, if B3 is larger than B5, that the ball is located between the posts, whereas if B3 is smaller than B4, the ball is located outside of the posts.

In FIG. 1 it becomes evident that if only B4 and not B3 is measured, if the value B3 is very small or below the measuring accuracy of the sensor, the ball is far away from the goal but by no means in the proximity of the goal line, if B1 and B2 can still be measured. If, however, neither B3 nor B4 are measurable, but B1 and B2 are measurable, the ball is very far away from the goal but in the proximity of the goal line, e.g. outside of the penalty area at the corner flag.

If no B1 but B2 is measured, the ball is far behind the goal, whereas if only B2 but no B1 is measured, the ball is relatively far away from the sensor, e.g. in the proximity of the penalty spot or even at the penalty area limit.

For vertical detection, a further comparator operation 62 is used in a special embodiment. In this case, a threshold 63 is compared with one or a plurality of magnetic field measuring values B1 and/or B2 and/or B3 and/or B4 to determine that if Bi (I=1, 2, 3 or 4) is larger than the threshold, the ball is below the crossbar, whereas if Bi is smaller than the threshold, the ball is above the crossbar.

In this embodiment a goal is therefore detected, if B1 is smaller than B2, if B3 is larger than B4 and if B1 or B2 or B3 or B4 or a majority vote from B1 to B4 or an average is larger than a threshold.

Only then is a goal signalized in the embodiment.

The functionalities of the means 60, 61, 62 take place in the embodiment for the evaluation device in a computer means 65 shown in FIG. 5B.

Preferably, a post-correction means 66 is provided, which in the case of an implementation is coupled to a memory 67, wherein the memory 67 stores either the last measured state or a state measured at an earlier time or a plurality of such earlier states.

It is particularly pointed to the fact that the functionality of the post-correction means 66 or a general plausibility check 60 on the basis of an earlier state and on the basis of a prior knowledge about typical and untypical or allowed and forbidden changes of state can also be used independent of magnetic field generating methods described with respect to the above-mentioned Figures. Even if a position is detected without magnetic fields e.g. due to wireless triangulation methods or optical methods, the prior knowledge can also be used about allowed or forbidden trajectories to carry out a plausibility check.

To check the plausibility, reference is made to FIG. 12a and FIG. 12b. It is again the situation of a soccer goal that is shown, wherein three basic areas are shown, namely a neutral area 120, a switch-off area 121 and a switch-on area 122. The neutral area 120 has two areas, namely an area 120a in front of the goal, which possibly borders the switch-on area 122, and a neutral area between the switch-on area and the goal line and a neutral area behind the goal line. Furthermore, reference is made to the switch-off areas, which extend from the posts 12a, 12b into the area behind the goal line. If a ball is for instance shot into the lateral net of the goal and for any reason rolls back into the field, i.e. moves virtually around the post, a goal is not indicated despite the fact that the functionalities of the comparators 60, 61, 62 are fulfilled due to the fact that the ball enters from the off-area into the neutral area.

Even if the ball virtually rolls from behind the goal into the neutral area, if for instance the net bends caused by a heavy shot, this will in any case not lead to a goal signalization, since the ball has passed the switch-off area, and, as may be seen from table 12b, a goal signalization is only possible if the ball comes from the switch-off area but has passed the switch-on area in the meantime. However, this is not the case, since a neutral area is located between the switch-on area 121 and the goalpost, which is not sufficient to activate a goal signalization for a ball that comes from the switch-off area, as may also be derived from the table shown in FIG. 12b.

It is pointed to the fact that the areas can vary depending on the goal, implementation, magnetic conductor positioning etc. and particularly also if detection methods other than magnetic detection methods are used. However, it will generally be possible everywhere to signalize a switch-off area that “crosses” a forbidden ball trajectory, so that a ball, if it is on such a trajectory, will not trigger a goal signalization despite the fact that it fulfils all “other” criteria.

The post-correction means 66 shown in FIG. 5b will therefore compare based on the table shown in FIG. 12b, as it may be deposited as a look-up table, the currently determined state supplied by the means 65 with the former state to find a respective line of the table in FIG. 12b to deactivate or not affect a goal indication. In order to update the memory 67, the last detected state or e.g. the state that has been detected some time ago is transmitted either by the post-correction means or by the evaluation logic, as it is indicated by the continuous or dotted return line 68 and 69.

FIG. 6 shows a schematic view of a field of a long conductor. It was found out that a conductor, if it has for instance a length of 25 m, as it is preferred for a goal with a width of 7.44 m, has a sufficiently large plateau in the center in terms of the magnetic field, in which the same magnetic field also exists at a same distance from the goal. However, the magnetic field significantly decreases towards the beginning and the end of the conductor. Towards the beginning of the conductor and towards the end of the conductor, the magnetic field has a value of only approx. 50% compared to the magnetic field at the plateau 82. Furthermore, it was detected that the magnetic field extends from the beginning of the conductor towards the left and from the end of the conductor towards the right, although a conductor does not exist there. The field has an 1/r characteristic.

In order that the plateau is sufficiently broad for a soccer goal it is preferred to provide a conductor length of at least 25 m for a goal height of approx. 2.40 m, wherein the conductor length becomes smaller if the goal is not that high, such as in ice hockey, or wherein the conductor length becomes larger if the goal is larger, such as in American football.

Furthermore, the width of the goal influences the length of the conductor, since the plateau becomes the broader the longer the conductor becomes. It is preferred in an implementation to use a conductor length of at least 10 m and particularly at least more than 20 m, wherein for a soccer goal with its typical dimensions at least 22 to 30 m and more are preferred, wherein the quality of the plateau 82, i.e. how far the plateau is to the ideal horizontal Iso-B line, is influenced by the length of the conductor.

FIG. 8 shows an alternative implementation of the magnetic field generating objects 15, 16.

While in FIG. 1 the return conductors are arranged far away from the area to be evaluated, the return conductors 150, 140 shown in the embodiment according to FIG. 8 are drawn around the field into the second goal area to also carry out a goal monitoring by using the same conductors. The same also applies to the perpendicularly arranged conductors 30, 40, which can also extend from the upper area in FIG. 8 to the lower area in FIG. 8 and which can therefore be used for evaluation in both goal areas. In order to save resources and due to the large dimensions of a soccer field, a safe decoupling is given in a manner that the first goal area does not interfere with the second goal area.

FIG. 9 shows an alternative implementation in which the forward conductors 14, 14 are not shielded, whereas the return conductors 140, 150 are magnetically shielded, e.g. by means of a metal. Thus, only the field from a forward conductor is located in the goal area if, the returning conductor is shielded, or only the field of the return conductor if the forward conductor is shielded. Thus, it is ensured at the expense of a larger shielding effort that due to the return conductors 140, 150 in FIG. 1 apparatuses are not disturbed that are located in this area.

FIG. 10a shows a further implementation of a magnetic field generating object in the form of a long coil 100 that is wound in opposite directions, which is arranged as first magnetic field generating object and/or as second magnetic field generating object, i.e. in the ground in front of and/or behind of the goal 102. Due to the fact that the coil is wound in opposite directions, a rotary field, that is drawn in dotted lines at 104, is compensated and not existent, while the coil totally develops a longitudinal field 106 which also has a decrease characteristic in proportion to l/r or a characteristic which, depending on the implementation, decreases from bottom to top. In this implementation, the problems of the forward conductor and the return conductor 13 and 140, respectively, is inherently solved in a manner that the forward conductor and the return conductor are used to compensate the rotary field 104 which is not required anyway, while shielding/interfering or any other problems with the return conductor do not exist. FIG. 10b shows a special schematic view of such a coil wound in opposite directions, which is designed such that the rotary field compensates itself while the longitudinal field exists.

The magnetic field generating objects are, generally speaking, straight conductors, namely particularly only the forward conductors, as shown in FIG. 1. If two movement ranges exist, the return conductors can also be used as magnetic generating objects, as shown in FIG. 8.

If a magnetic field generating object is considered as a coil with one single winding, the diameter of the winding is substantially larger in the embodiments of FIGS. 1 and 8 than the surface in the movement range with respect to which the position of the mobile object is to be detected. From the numeric point of view the proportion of the surface that is to be monitored by the magnetic field generating objects is approximately such that the surface of the conductor loop in the case of FIGS. 1 and 8 amounts to at least 5 times and preferably to an even larger multiple of the goal surface. If the return conductor is shielded, as is the case in FIG. 9, the return conductor can be attached close to the forward conductor and the surface of the conductor loop formed in this way is very small. However, this is unproblematic in view of the magnetic efficiency, since the return conductor is shielded and does therefore not compensate the magnetic field of the forward conductor.

In the case of the use of the long coil wound in opposite directions, a coil is preferably used whose diameter is relatively small, e.g. smaller than 50 cm, preferably smaller than 10 cm. Generally speaking, the cross-sectional surface of the coil in the transverse direction, i.e. perpendicular with respect to the extension direction of the coil, i.e. with respect to FIG. 10a, is much smaller in the xz-direction than the surface to be examined, e.g. smaller than 1/50 or even smaller. In contrary, the length of the coil in the extension direction, i.e. in the y-direction of FIG. 10a is at least twice as large and preferably even larger than the length of the surface with respect to which the position of the mobile object can be determined.

In view of the dimension of the long coil wound in opposite direction it is also pointed to the fact that the length of the coil compared to the cross section of the coil in the xz-direction is larger by at least the factor 20 and is preferably even larger.

Depending on the circumstances, the method according to the invention can be implemented into hardware or software. The implementation can be made on a digital storage medium, particularly a disk or CD with electronically readable control signals that can cooperate with a programmable computer system so that the method is carried out. Generally, the invention also relates to a computer program product comprising a program code stored on a machine-readable carrier to carry out the method according to the invention if the computer program product runs on a computer. In other words, the invention can therefore be realized as a computer program by a program code to carry out the method if the computer program runs on a computer.

1. Movement range for a mobile object (11), whose position is to be detected with respect to a surface (19) in the movement range, wherein the
movement range has a ground (21) and the surface intersects the ground along an intersecting line (20), comprising the following features:
a first elongate magnetic field generating object (14), arranged at a first distance (d₁) from the intersecting line on a first side of the intersecting line in or on the ground;
a second elongate magnetic field generating object (15) arranged at a second distance (d₂) from the intersecting line (20) in or on the ground (21);
wherein the first magnetic field generating object and the second magnetic field generating object are adapted to generate a magnetic field decreasing with a radially increasing distance with respect to the magnetic field generating object; and
a generator (16) for controlling the first magnetic field generating object and the second magnetic field generating object with a current and a multiplex mode.

2. Movement range as claimed in claim 1, in which the first magnetic field generating object (14) comprises a conductor (14) or a plurality of conductors, arranged substantially in parallel and connected to the generator (16) in a manner that a current flowing through the conductors flows in any conductor of the plurality of conductors in the same flow direction.

3. Movement range as claimed in claim 1, in which the first or the second magnetic field generating object comprises a coil (100), which is wound in a manner that a supply and a discharge are arranged on the same side of the coil in the longitudinal direction so that the coil in excited condition generates a magnetic field in the surface (19) which comprises a dominant magnetic field vector in the direction of the coil and which decreases at an increasing distance from the coil.

4. Movement range as claimed in claim 3, in which the coil comprises windings, wherein between two windings in which the current flows in one direction, a winding is located in which the current flows in the opposite direction.

5. Movement range as claimed in claim 1, in which the first magnetic field generating object (14) and the second magnetic field generating object (15) comprise a conductor and a return conductor (140, 150), wherein the return conductor (140, 150) is magnetically shielded (141, 151) so that a field is influenced more by the forward conductor than by the return conductor due to a current through the conductor.

6. Movement range as claimed in claim 1, in which the first magnetic field generating object (14) or the second magnetic field generating object (15) comprise a forward conductor and a return conductor, wherein the return conductor is spaced apart from the surface (19) to such an extent that a magnetic field amount caused by a current in the return conductor in the surface amounts to a maximum of one percent of a magnetic field amount in the surface caused by the forward conductor.

7. Movement range as claimed in claim 1, said movement range being arranged in a playing field, wherein the playing field comprises a further movement range, wherein the first magnetic field generating object (14) or the second magnetic field generating object (15) each comprise a forward conductor and a return conductor, wherein the forward conductor is arranged in a movement range, and the return conductor is arranged in a further movement range, and wherein the first movement range and the second movement range are spaced apart to such an extend that a field caused by a current in a conductor in the respective other movement range is smaller than one percent of the field caused by the conductor arranged in the movement range.

8. Movement range as claimed in claim 1, in which the first distance (d₁) is equal to the second distance (d₂).

9. Movement range as claimed in claim 1, in which the surface is laterally limited and defined by a goal or is situated in parallel to a surface limited by the goal about a predetermined distance spaced apart behind the goal, wherein the predetermined distance (d₃) depends on a dimension of the mobile object.

10. Movement range as claimed in claim 1, in which the mobile object is a soccer ball which comprises a magnetic field sensor (9) in a central portion thereof, wherein the predetermined distance (d₃) corresponds to substantially half of the diameter of the soccer ball in a manner that a revolution line (36) around the predetermined distance (d₃) is arranged behind a goal line.

11. Movement range as claimed in claim 1, in which the surface is laterally limited and in that a third magnetic field generating object (30, 40) is arranged in the proximity of the lateral limitation.

12. Movement range as claimed in claim 11, in which the third magnetic field generating object extends within the surface on or in the ground.

13. Object according to claim 11, in which furthermore a fourth magnetic field generating object (40) is arranged which extends outside the lateral limitation (12) in or on the ground (21).

14. Movement range as claimed in claim 1, in which the generator (16) is formed to operate the magnetic generation objects in a time multiplex mode, a frequency multiplex mode, a code multiplex mode or a combined time/frequency multiplex mode, time/code multiplex mode or frequency/code multiplex mode.

15. Movement range as claimed in claim 1, in which the generator (16) is adapted to feed-in an identical alternating current amplitude into each magnetic field generating object, or to feed-in different amplitudes depending on a conductor length and/or on a conductor resistance and/or on the first distance (d₁) or the second distance (d₂).

16. Movement range as claimed in claim 15, in which the generator (16) is adapted to feed-in a larger current amplitude into a magnetic field generating object compared to a different magnetic field generating object if a distance of the one magnetic field generating objects to the intersecting line (20) is larger than distance of the other magnetic field generating object to the interesting line (20).

17. Evaluation device for detecting a position of a mobile object (11) with respect to a surface in an movement range, wherein the movement range (5) has a ground (21) and the surface (19) intersects the ground, comprising the following features:
a means (7, 8, 5) for supplying a first magnetic field caused by a first magnetic field generating object and a second magnetic field caused by a second magnetic field generating object, wherein the first and the second magnetic field generating objects (14, 15) are arranged at a first distance (d₁) or a second distance (d₂) from the intersecting line (20) on different sides in or on the ground (21); and
a computer means (65) for determining whether the mobile object is or was located in front or behind of the surface based on a comparison (60, 61) of the first magnetic field (B1) with the second magnetic field (B2).

18. Evaluation device as claimed in claim 17, in which the first distance (d₁) and the second distance (d₂) are identical or in that current amplitudes are set by the magnetic field generating objects in a manner that the magnetic fields in the surface are identical within a tolerance range, wherein the tolerance range has a value of plus or minus 10 percent, and
in which the computer means is adapted to detect a position of the mobile object (11) in front of the surface if the first magnetic field is larger than the second magnetic field, or to detect a position of the mobile object (11) behind the surface if the first magnetic field is smaller than the second magnetic field.

19. Evaluation device as claimed in claim 17, in which the surface is laterally limited and in which a third magnetic field generating object (30, 40) is arranged in the proximity of the lateral limitation,
wherein the supplying means is adapted to supply a third magnetic field and wherein the computer means is adapted to compare (62) the third magnetic field with a threshold (63).

20. Evaluation device as claimed in claim 17, wherein in the movement range a third magnetic field generating object (30) and a fourth magnetic field generating object (40) are arranged, wherein the third magnetic field generating object is arranged within the surface in or on the ground, and wherein the fourth magnetic field generating object is arranged outside of the surface in or on the ground,
wherein the supplying means is adapted to supply a third magnetic field and a fourth magnetic field based on the third magnetic field generating object or the fourth magnetic field generating object, and wherein the surface means (65) is adapted to compare the third magnetic field and the fourth magnetic field with one another, wherein as soon as the third magnetic field is larger than the fourth magnetic field, a position of the mobile object within the lateral limitation can be detected, wherein if the third magnetic field is smaller than the fourth magnetic field, a position of the mobile object outside of the limitation can be detected.

21. Evaluation device as claimed in claim 17, in which the surface (10) is limited in the upward direction (41) and in which the computer means (65) is adapted to compare (62) the first magnetic field, the second magnetic field, the third magnetic field or the fourth magnetic field or a combination of magnetic fields by an average of a plurality or all magnetic fields or a majority decision among a plurality or all magnetic fields with a threshold (63), wherein if the comparison delivers a smaller value than the threshold it can be detected that the mobile object is located below the upper limit, whereas if the comparison delivers a larger magnetic field than the threshold it can be detected that the mobile object is or was located above the limitation.

22. Evaluation device as claimed in claim 17, in which the surface is a goal, in which the mobile object is a ball and in which a goal can at most be detected if the first magnetic field is smaller than the second magnetic field, if a third magnetic field as a result of a magnetic field excitation state extending between two goal posts is larger than a fourth magnetic field caused by a magnetic field generating object extending outside of the goal posts, and furthermore the first magnetic field, the second magnetic field, the third magnetic field and the fourth magnetic field and/or a combination thereof is larger than a threshold (63).

23. Evaluation device as claimed in claim 17, in which the computer means is adapted to detect whether a moved object is located in front of the surface or behind the surface and whether the object is located within a lateral limitation or outside of a lateral limitation, which is carried out only by comparison operations between two measured values that can be detected in one or a plurality of multiplex cycles on the basis of different magnetic generating objects.

24. Evaluation device as claimed in claim 17, further comprising the following features:
a post-correction means (66) for verifying whether a result generated by the computer means (65) is plausible by using a result measured in an earlier time interval.

25. Evaluation device as claimed in claim 24, in which a switch-off range (122) exists, which does not comprise the surface, a neutral range (120a, 120b) in which the surface is located and a switch-on range (121), which is arranged with respect to the surface in a manner that an expected trajectory of the mobile object (11) extends through the switch-on range, wherein the post-correction means is adapted to allow a signalization of a certain position with respect to the surface only if the mobile object was located at an earlier time in the switch-on range (121) or the neutral range (120a, 120b).

26. Evaluation device as claimed in claim 24, in which a signalization can be deactivated if the mobile object has a current position located in the switch-off range (122).

27. Evaluation device as claimed in claim 24, in which a signalization remains deactivated if an earlier position was in the switch-off range, and a current position is in the neutral range (120a, 120b).

28. Evaluation device as claimed in claim 27, in which the surface is a goal with two posts and a crossbar, in which the switch-on range (121) comprises an arcuate range in front of the goal within the playing field;
in which the switch-off range (122) is located behind the goal post, wherein a range is limited behind a goal post and borders a neutral range towards the inside,
wherein furthermore, a neutral range (120b) is arranged in front of the switch-on range and between the switch-on range and the goal and behind the goal, wherein the switch-on range, the neutral range and the switch-off range do not overlap.

29. Evaluation device as claimed in claim 17, which is arranged within the mobile object (11), and in which the means for supplying the first magnetic field and the second magnetic field comprises a direction-independent amount-magnetic field sensor (9), and which furthermore comprises an output means for optically, acoustically or electromagnetically outputting a goal decision.

30. Evaluation device as claimed in claim 17, which is formed outside of the mobile object (11), in which the supplying means comprises an input interface (5) to receive magnetic fields transmitted by the mobile object (11).

31. Evaluation device for detecting a position of a mobile object with respect to a surface in a movement range, wherein the movement range comprises a ground (21) and the surface intersects the ground along an intersecting line (20), comprising the following features:
a plausibility analyzation means (66) for verifying whether a result generated by a position detection means is plausible by
using a result measured during an earlier time interval and by using a prior knowledge about valid or invalid trajectories of the mobile object (11).

32. Method of operating a movement range for a mobile object (11), whose position must be detected with respect to a surface (19) in the movement range, wherein the movement range comprises a ground (21) and the surface intersects the ground along an intersecting line (20), comprising the following steps:
generating a first magnetic field by a first elongate magnetic field generating object (14) arranged at a first distance (d₁) from the intersecting line on a first side of the intersecting line in or on the ground;
generating a first magnetic field by a second elongate magnetic field object (15) arranged at a second distance (d₂) from the intersecting line (20) in or on the ground (21);
wherein the first magnetic field generating object and the second magnetic field generating object are adapted to generate a magnetic field radially decreasing with respect to the magnetic field generating object at an increasing distance; and
controlling (16) the first magnetic field generating object and the second magnetic field generating object by a current and a multiplex mode.

33. Method of detecting a position of a mobile object (11) with respect to a surface in a movement range, wherein the movement range (5) has a ground (21) and the surface (19) intersects the ground, comprising the following steps:
supplying (7,8,5) a first magnetic field based on a first magnetic field generating object, and a second magnetic field based on a second magnetic field generating object, wherein the first and the second magnetic field generating object (14, 15) are arranged at a first distance (d₁) or a second distance (d₂) from the intersecting line (20) on different sides in or on the ground (20); and
detecting (65) whether the mobile object is or was located in front of or behind the surface on the basis of a comparison (60, 61) of the first magnetic field (B1) with the second magnetic field (B2).

34. Method of detecting a position of a mobile object with respect to a surface in the movement range, wherein the movement range comprises a ground (21) and the surface intersects the ground along an intersecting line (20), comprising the following steps:
verifying (66) whether a result detected by a position detection means is plausible by using a result measure during an earlier time interval and by using a prior knowledge about valid and invalid trajectories of the mobile object (11).

35. Computer program comprising a program for carrying out the method according to any of claim 32, 33 or 34 if the program runs on a computer.
